(19) United States
(12) Patent Application Publication
(10) Pub. No.: US 2005/0279016 A1
(43) Pub. Date: Dec. 22, 2005

(54) Floating aquatic emergence trap

(76) Inventors: Gregory M. Williams, Newark, DE (US); John B. Gingrich, Milton, DE (US)

Correspondence Address: McCarter & English LLP;Citizen Bank Center, 919 N Market Street Suite 1800, P O Box 111, Wilmington, DE, 19899, US

(21) Appl. No.: 10/869,651

(22) Filed: Jun. 16, 2004

(51) Int. Cl. A01M 1/10

(52) U.S. Cl. 43/122; 43/107

(57) ABSTRACT

The present invention is an insect emergence trap that is substantially pyramidal shaped. The trap of the invention is adapted to withstand wet outdoor conditions by being more durable while also being relatively simple to assemble and cost effective.

### FIELD OF THE INVENTION

The present invention is directed to an emergence trap designed to capture emerging insects from various locations. More specifically, the invention is directed to a truncated pyramidal-shaped emergence trap that is more durable and adaptable to severe weather conditions.

### BACKGROUND OF THE INVENTION

Different types of emergence traps have been widely used for sampling aquatic insects in both deep and shallow waters. These traps can be divided into two broad categories, the first being those such as funnel traps which are completely submerged in the water, and the second being those which either float on or are positioned above the water. Generally, traps that are positioned over the water are the best for sampling mosquitoes. Such emergence traps are effective for studying mosquitoes, for example, breeding habits, diet and seasonal patterns of emergence and estimates of adult productivity.

A wide variety of emergence traps have been designed and used over the years, each attempting to best and most efficiently capture insects of interest. The present invention is directed to a floating trap type structure. The prior art discloses a variety of floating trap structures.

Aubin et al. (1973) developed a floating pyramidal trap to kill mosquitoes and preserve them in good taxonomic condition, and to function effectively in very shallow waters. The Aubin trap is shown FIG. 1 of this document. It consists of an 18-cm high truncated pyramid of 3 mm plexiglas with a 25 cm square base supported on a styrofoam framework. An 8.5 cm square plexiglas plate with a large hole removed from its center is glued on the top of the pyramid. The cap of a wide mouth 8 oz glass jar with a 4 cm diameter hole removed from the center is fixed within the hole in the Plexiglas plate. A plastic funnel is glued to the inside of this cap to both guide mosquitoes into the collecting jar and to retain the 25 ml of formaline which are poured around the edges of the cap. There are some problems, however, associated with the Aubin trap. First, the base of the Aubin trap is made out of stryrofoam which tends to get water-logged over time, and thus needs replacing. Second, the sides of the Aubin trap are made of plexiglas sheets which cause the temperatures inside the trap to rise to levels which can be lethal to the insects one is attempting to catch. Third, the insect collection jar of the Aubin trap is glass and does not hold up well to the hard use that the traps see in the field. Additionally, the collection jar of the Aubin trap is not ventilated and is intended to kill the insects upon capture.

Modifications of the Aubin trap have been developed over the years to correct some of the noted problems. For instance, LeSage and Harrison (1979) designed a trap that uses a base constructed of plastic tubing and is covered with netting. The insects are collected by removing the entire collection net and jar. This form presents problems in that removal and replacement of the entire collection net is tedious and time consuming. Further, as determined by the inventors of the present application, the vertical supports are attached to the base in an insecure fashion that is problematic over the long term in typical outdoor conditions.

Smith & McIver (1984) attempted a new Aubin style trap that used a wooden frame where the base was covered with polyethylene sheeting. Also included was a netting sleeve through which a vacuum could be inserted to collect the mosquitoes that did not fly up to the collection jar. Again, this device resulted in a tedious collection process that is not very efficient. Further, the wooden frame is susceptible water damage, and, as such, not very durable over time.

Appleton & Sharp (1985) attempted their own modified trap based on the Aubin trap. Their trap consisted of a square, resin-coated polystyrene base supporting four brass rods that formed a pyramid. There was no collection bottle used. Instead, the pyramid was covered with netting to which a sleeve, was attached for the removal of the mosquitoes. The lack of a collection bottle at the top results in another tedious and time consuming process of insect collection as the removal of insects from a sleeve is an involved process.

With all these various forms of emergence traps developed over the years, there clearly remains a need for an emergence trap that is more durable over repeated use in aquatic conditions; that provides a means for keeping the trapped insects alive; that prevents high temperatures from occurring within the trap; and that is light, simple to use and cost effective and that may be used either as a floating or semi-submerged trap.

### SUMMARY OF THE INVENTION

In one aspect, the invention is an insect emergence trap comprising:

(a) a watertight rigid open base comprising water impervious pipe forming a polygon;

(b) a plurality of solid upright supporting rods attached to said pipe and extending from said base at fixed angles thereof;

(c) a top supported by said rods substantially parallel to said base wherein said top comprises a sheet having an area smaller than an area of said base and comprising an opening therethrough;

(d) a screen material attached to said base and said rods extending between said base and said top sheet forming an enclosure over said base thereby to trap an emerging insect between said top sheet and said base; and

(e) a ventilated insect collecting container removably mounted over said top opening and fully covering said opening, said container comprising an inverted funnel within said container positioned directly over said top opening when said container is mounted on said top;

wherein said pipe of said base has a diameter selected to float said insect emergence trap over water with said base partially submerged.

### BRIEF DESCRIPTION OF THE DRAWINGS

FIG. 1 shows in schematic representation an emergence trap according to the prior art.

FIG. 2A is a schematic representation of the lower portion of one embodiment of the emergence trap in accordance with the present invention.

FIG. 2B is a schematic representation of the top portion of the trap illustrating an insect collection container for use with the trap shown in FIG. 2A.

FIG. 3 shows a schematic perspective view of a fully assembled trap according to one embodiment of the present invention.

FIG. 4 is a schematic elevation view of the trap shown in FIG. 3.

FIG. 5 is a schematic perspective view of the trap shown in FIG. 3 floating on a body of water and having an anchor line and an anchor extending therefrom.

FIG. 6 is a schematic top view of the trap shown in FIG. 3 including the incorporation of eyelets.

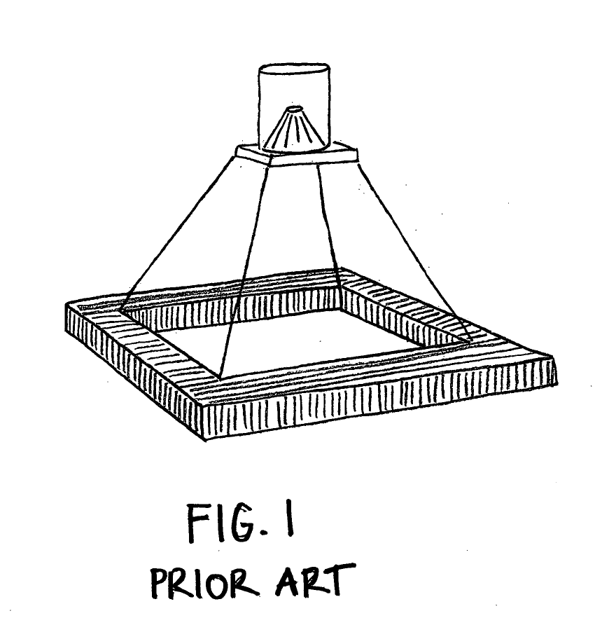

### DETAILED DESCRIPTION OF THE INVENTION

The invention will next be described with reference to the figures where same numerals are used in all figures to identify same elements. The figures are intended to illustrate the invention and do not include elements not essential for this purpose, nor are they in scale.

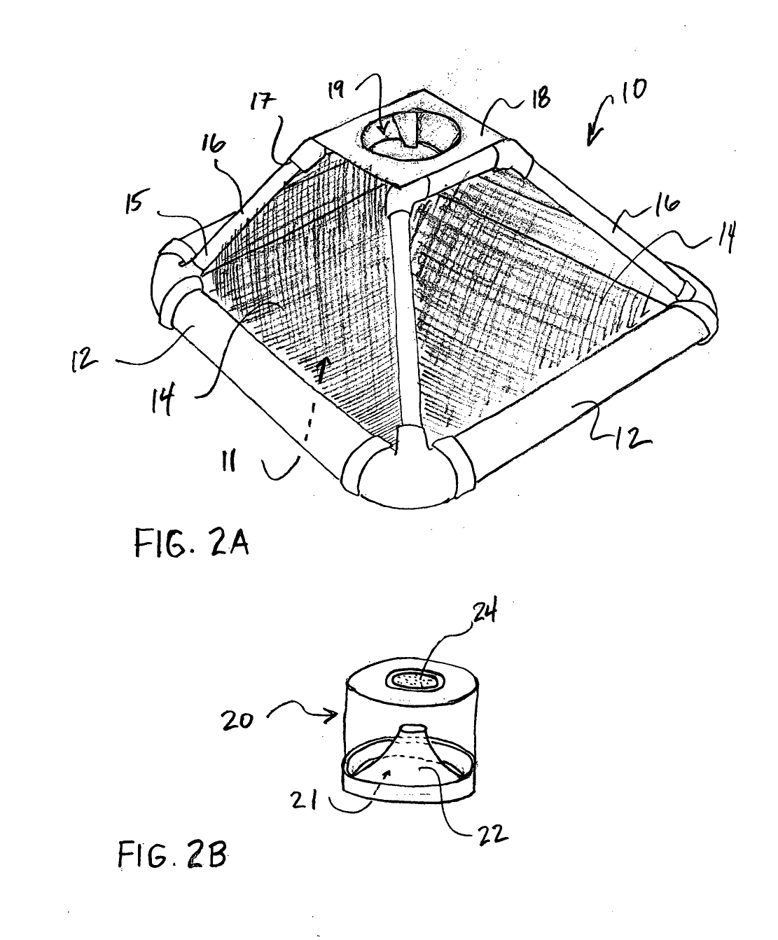

Referring next to FIG. 2A there is shown an emergence trap 10 according to the invention. Preferably the trap is shaped as a pyramidal-shaped device comprising a base 12, sides 14, supporting rods 16, and a top 18. Shown in FIG. 2B is a collection container 20 that is adapted to be removably attached to the top 18 of the trap 10. A pyramidal shape is desired because insects are known to have a tendency to fly upwards when confronted with an obstacle. In the case of a pyramidal structure, the insects will fly upwards following the angled sides 14 of the trap towards the top 18 and into the collection container 20. Those having skill in the art are familiar with the pyramidal style of emergence trap, which are known to be effective for such purposes.

The base 12 can comprise any desired shape. Because cost and ease of assembly are important features of the invention, shapes that have straight sides are preferred. Some examples include a square, rectangle, triangle, or any other polygonal shape. Base 12 is depicted in the figures as a substantially square perimeter surrounding an opening 11 through which the insects enter the trap 10 from the water or other location over which the trap rests.

Base 12 preferably comprises rigid plumbing pipe such as standard PVC pipe. Also effective are other rigid pipe materials such as CPVC or ABS. In general, plumbing pipe is preferred because not only is it durable and water-resistant, but in addition, due to its tubular shape, the pipe will naturally partially submerge under the surface of water when placed thereon. The corners of the base can be connected by any known method that provides a tight seal, such as, for example, standard pipe fittings that can be sealed using primer and cement. Threaded fittings can also be used to enable the disassembly of the trap. It is further preferred that the pipe have a diameter that provides the trap 10 with sufficient flotation and the greatest durability while not being too bulky or heavy. As such it is preferred that the pipe be at least ½ inch, more preferably at least 1 inch and most preferably at least 2 inches in diameter.

An added benefit of using standard plumbing pipe is that it provides the trap 10 with the ability to partially submerge thus keeping unwanted creatures from entering the trap 10 from under the base 12 as will often occur with the wooden or Styrofoam™ bases used in the prior art that tend to float over the water surface.

The dimensions of the perimeter base 12, or, in other words, the size the opening 11, can vary significantly depending upon the size of the trap needed. For example, should the habitat of the insects be a small area (i.e. a creek or crab hole), then a smaller trap will likely be preferred, and, accordingly, a smaller perimeter base will be used. In other cases, the habitat may be large (i.e. a bay), wherein the size of the trap can be unlimited depending only upon constraints such as weight and bulkiness. In a preferred embodiment used by the inventors, the size of opening 11 is ½ square meter in diameter.

The sides 14 of the trap 10 are defined by supporting rods 16 that extend from the base 12 and attach to the top 18. The fore end 15 of each rod 16 is fixedly attached to base 12, while the aft end 17 of each is fixedly attached to the top 18. The rods 16 are preferably attached to the base 12 to form a tight seal such as with the use of standard pipe fittings. Because the angles of a pyramidal shaped trap are not adapted for standard “T”-type fittings, it is preferred that end caps be attached to the elbow pieces with, for example, self-tapping screws as described in Example 1. While it is preferred that the rods 16 each be of approximately equivalent length, there is no limitation as to what that length is. Because the shape of the trap is pyramidal, the length of the rods 16 will be dictated by the size of the base 12 and the top 18. Those having skill in the art can readily design appropriately sized rods 16 to form a trap having a pyramidal shape.

Top 18 preferably comprises a flat sheet having a hole 19 formed there through (see FIG. 2A). Top 18 is preferably disposed substantially parallel to base 12. Although top 18, like base 12, is also preferably substantially polygonal-shaped for ease of design, top 18 can be any shape. Should an alternate shape be used, it is preferred that top 18 have generally the same shape as the base 12 again for ease in assembly. In order to form a pyramidal shape as is desired here, the top 18 has a smaller area than the area of base 12. Top 18 is preferably made of a durable, flexible material such as, for example, plastic, sheet metal, carbon fiber sheet or fiberglass sheet, among others.

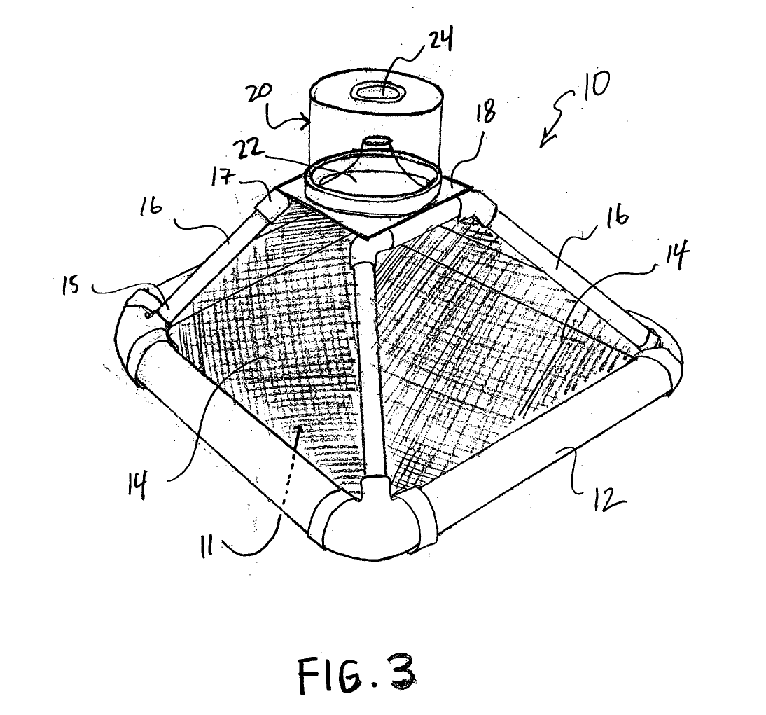

In a preferred embodiment of the fully assembled trap 10 depicted in FIG. 3, the base 12 and the top 18 are each substantially square-shaped and disposed substantially in parallel to each other, with the top 18 having a smaller diameter than the base 12. In this embodiment there are provided four supporting rods 16 of relatively equal length, the fore end 15 of each rod 16 attached to one of each the four corners of the base 12. The aft end 17 of each rod 16 is attached to the reciprocal corner of the top 18. Because the top 18 is smaller in diameter than the base 12, the attachment of the base 12 to the top 18 using the four rods 16 forms a pyramidal shape.

As discussed earlier, sides 14 are defined by the supporting rods 16. It is important that the sides 14 of the trap 10 be enclosed in order to retain the insects therein and force them to the top of the trap. Ventilated sides 14 are preferred in order to minimize heat production within the trap 10. As such, any ventilated material can be used to enclose the sides 14 of the trap 10. It is preferred that such material be strong and durable in wet, outdoor conditions and further, that the holes in the ventilated material be smaller than the insects to be trapped in order to keep them retained therein. In a preferred embodiment, the ventilated material enclosing the sides 14 of the trap 10 comprises fiberglass window screen. Some additional examples of acceptable ventilated material include aluminum window screen, polyester netting, muslin, chiffon, Lunite® screen, monofilament screen, and plankton netting.

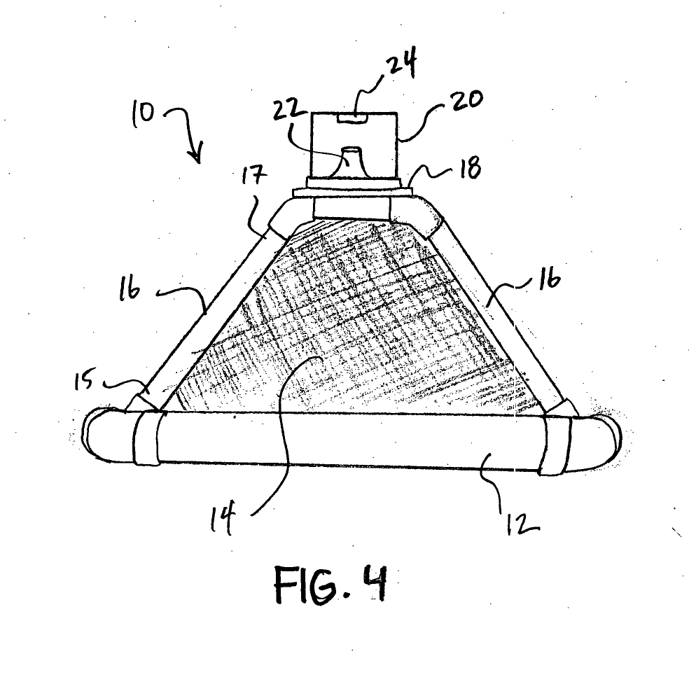

As better shown in FIG. 2B, removably attachable to the top 18 of the trap is a collection container 20 where the insects are collected. The collection container 20 is adapted to removably attach to the upper surface of the top 18 over the hole 19 in such a way that the container 20 completely covers the hole 19 such that no insects can escape. As best viewed in FIGS. 3 and 4, the collection container 20 forms the peak of the pyramid-shaped trap where all of the insects are forced to fly into and eventually become trapped. The container 20 comprises a jar-like structure, comprised of a durable material, having an opening 21 at one end that corresponds to hole 19 of the top 18 of the trap. It is preferred that once the insects enter the container that a means for keeping the insects from getting back out of the container 20 be provided. In a preferred embodiment, such means is accomplished via an inverted funnel 22 extending inward from the opening 21. The inverted funnel 22 is an effective means by which the insects enter the container 20 without being able to escape. An alternative means for retaining the insects within the container 20 includes the insertion of a plate or card having a tacky or sticky substance applied thereon and to which the insects would stick.

In a preferred embodiment, the container 20 is designed to keep the insects alive while trapped within. As such, the container 20 is preferably ventilated. In a preferred embodiment best depicted in FIG. 2B, the ventilation is accomplished by incorporation of a screened portion 24 on the top of the container. It is important that the material used for ventilation have pores small enough to contain the insects within the container 20. It is conceivable, however, that ventilation of the container 20 can be accomplished in a variety of ways, including, for example, an entirely screened container Alternatively an unventilated container could be used if it is unnecessary to keep the insects upon capture. The addition of an insecticide such as ethyl acetate or ammonium carbonate in an unventilated container will speed up the killing process.

Because the trap remains in the outdoors in all types of weather conditions, it is clearly preferred that the collection container 20 be made of a durable material. Also, while not critical, it is preferred that the material be translucent, allowing the insects to be visible within the container to make it simpler to determine when the container is full or whether unwanted creatures, such as spiders, have made their way into the container. While it is preferred that the container 20 be made of plastic or vinyl, a metal or glass container will also be effective.

The collection container 20 is removably attached to the top 18 over the hole 19 such that it can be removed periodically to remove and collect the trapped insects and then be replaced. In a preferred embodiment, the hole 19 and the collection container 20 are adapted to communicate via a threading system such that the container 20 can be screwed tightly into the hole 19. While a threading system is preferred, any method can be used so long as the container 20 is not fixedly attached to the top 18 in such a way that it cannot be readily removed, such as, for example, with the use of a gasket, an o-ring, tape, a clamp or velcro®.

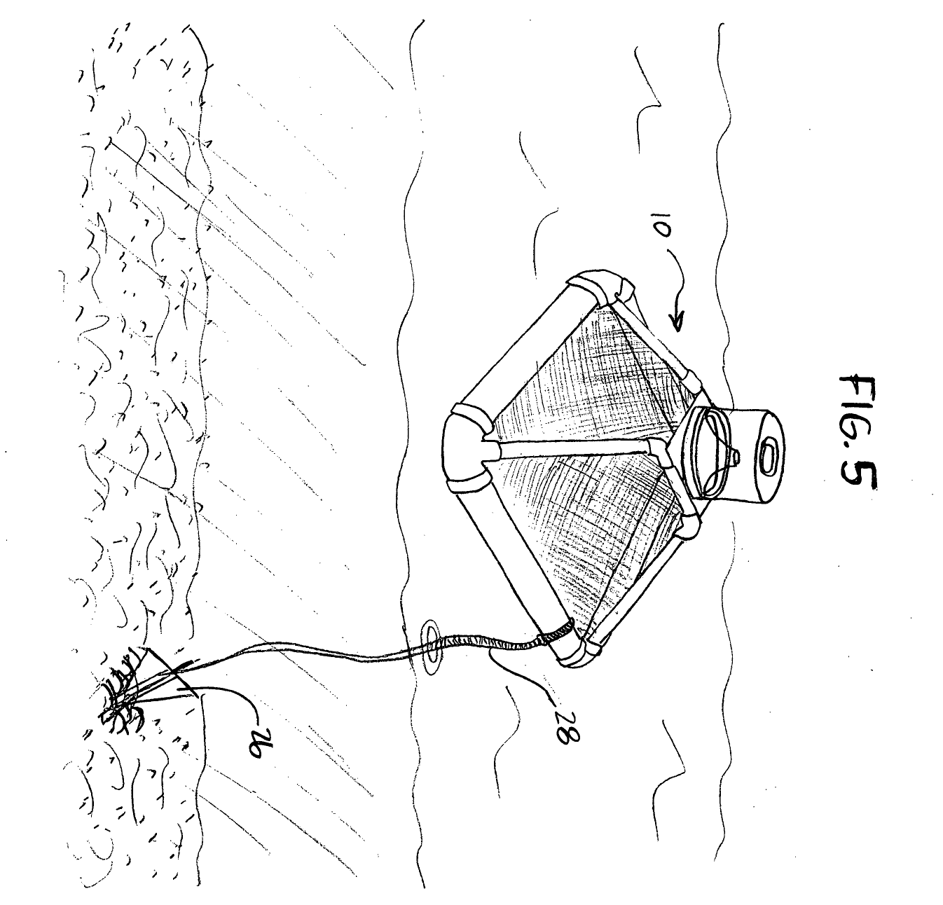

In use, the trap 10 is adapted to be placed over a location from which insects emerge, such as, for example, a body of water, wells, sewer grates, crab holes, and any other insect breeding habitats. If the trap 10 is on a body of water, it can be left to float across the surface of the water or, alternatively, it can be anchored in some way. In one embodiment depicted in FIG. 5, the trap 10 incorporates at least one anchor 26 that is tied to the base 12 using at least one anchor line 28 such as, for example, rope. Alternatively, in place of an anchor, weights can be used. In order to accommodate for changing tides, enough slack should be left in the anchor lines 28 to allow the trap 10 to rise and fall with the water level. This method will keep the trap 10 in one general location but the trap will move within the range of the anchor lines.

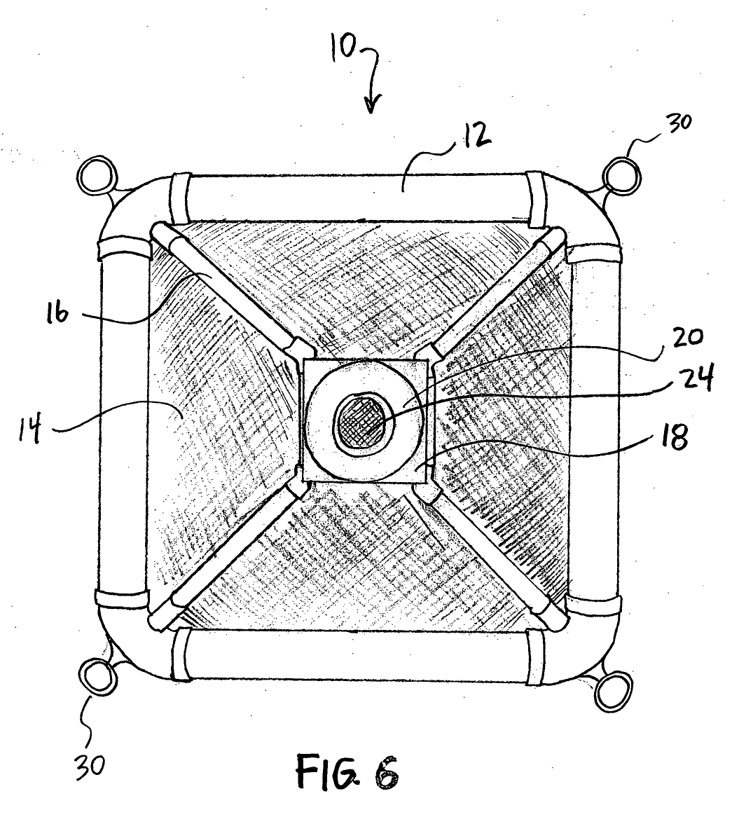

In an alternative embodiment depicted in FIG. 6, one or more eyelets 30 can be attached to the base 12 such that the trap 10, via the eyelets 30, can be placed over one or more stakes that are secured into the ground under the water. This will allow the trap to rise and fall with the water levels but will keep the trap in one fairly specific location.

In the use of many traps of the prior art, joints in the trap tend to leak generally because they are not carefully or well assembled. It is thus a preferred feature of this invention that the joints be carefully and well assembled in such a way as to minimize leakage to the fullest extent. Some ways to overcome leakage include 1) detailed cutting, gluing, and assembly of joints, 2) using threaded piped to assemble the traps, or 3) filling the base of the trap with an acceptable filler, such as, for example, an expanding foam product. With regard to attachment of the screen, it is preferred that it be stitched around the perimeter base of the trap for a more durable construction. Generally, the trap of the invention can be readily assembled using standard parts that are sold in standard hardware store throughout the United States. Example 1 provides a specific example of the assembly of a trap of the invention.

### EXAMPLES

### Example 1

### Assembly of a Pyramidal Trap

Materials:
2 inch 90° PVC joint
2 inch×10° PVC pipe
½ inch 45° PVC joint
½ inch×10 foot PVC pipe
½ inch PVC pipe cap
4 foot×8 foot plastic sheet
PVC primer
PVC cement
Fiberglass screen 36 inch×100 foot
Mosquito breeder
Extra breeder funnel
Hot glue sticks
Caulk
#8×½ inch screws
#8×1 inch screws
Aluminum rivets
   Assembly

All cutting can be accomplished with a PVC hand saw, circular saw or miter saw.

Step 1. Cut the 2 inch PVC pipe into four 17.5 inch pieces. The pieces of 2 inch pipe are cemented into the 90° PVC joints to form a square base. This base provides approximately ½ meter² of sampling area.

Step 2. Cut the ½ inch PVC pipe into four 10 & ½ inch pieces and two 6 inch pieces. Use the ½ inch 45° joints to join the pieces together as shown above. Disassemble the mosquito breeder into individual parts. Add an air hole to bottom cup of breeder.

Step 3. Use the 1 inch self-tapping screws to drill the ½ inch PVC pipe caps to the corners of the base. Angle the caps at approximately 45°. Caulk under the cap before screwing it all the way down to prevent leaks. Cement the two top supports to the caps in the base.

Step 4. Cut a 6 inch×6 inch square piece from the plastic sheet. Screw the piece into the 45° joints at each corner with the ½ inch self-tapping screws. Cut a hole our of the center of the top. Rivet one mosquito breeder lid onto the top piece.

Step 5. Cover the tap with the screen. Cut off enough screen to cover one side. The screen is attached with hot glue. The most effective way to glue the screen on is to press the end of the hot glue gun firmly against the screen and apply glue so that it goes through the screen and onto the PVC. It is important that enough glue be applied so that it encircles the fibers of the screen. This is accomplished by starting with gluing the screen along one side of the top, and then down each support. Repeat for the other three sides. Finish by gluing the screen to the base. Enough slack should be left in the screen so that it is less likely to pull off.

The trap of the invention can serve a variety of purposes, for example, i) the trap can be used to sample mosquito larvae which breathe through aquatic plant stems such as Coquilletidia and Mansonia species which cannot be sampled through traditional dipping methods; ii) the trap can be used to collect a representative sample of any emerging arthropods from an aquatic environment, or iii) with the use of mathematical models, the trap can be used to estimate the relative abundance of emerging insect populations from a body of water. In addition to the uses mentioned above, the trap can be placed over wells, cisterns, sewer grates, crab holes or other similar insect breeding habitats to sample the emerging insect populations.

Although the invention is illustrated and described herein with reference to specific embodiments, the invention is not intended to be limited to the details shown. Rather, various modifications may be made in the details within the scope and range of equivalents of the claims and without departing from the invention.

1. A pyramidal insect emergence trap comprising:
(a) a watertight rigid open base comprising water impervious pipe forming a polygon;
(b) a plurality of solid upright supporting rods attached to said pipe and extending from said base at fixed angles thereof;
(c) a top supported by said rods substantially parallel to said base wherein said top comprises a sheet having an area smaller than an area of said base and comprising an opening therethrough;
(d) a screen material fixedly attached to said base and said rods extending between said base and said top sheet forming an enclosure over said base thereby to trap an emerging insect between said top sheet and said base; and
(e) a ventilated insect collecting container removably mounted over said top opening and fully covering said opening, said container comprising an inverted funnel within said container positioned directly over said top opening when said container is mounted on said top;
wherein said pipe of said base has a diameter selected to float said insect emergence trap over water with said base partially submerged.

2. The emergence trap according to claim 1 wherein said rods also comprise pipe.

3. The emergence trap according to claim 2 wherein said top sheet is flexible.

4. The emergence trap according to claim 1 wherein said base is substantially a rectangle.

5. The emergence trap according to claim 4 wherein said rectangle is a square:

6. The emergence trap according to claim 5 wherein said base comprises a plurality of straight sections of polyvinyl plumbing interconnected through a plurality of angled plumbing fittings.

7. The emergence trap of claim 1 wherein the base comprises PVC pipe.

8. The emergence trap of claim 7 wherein the diameter of the PVC pipe is at least about one-half inch.

9. The emergence trap of claim 8 wherein the diameter of the PVC pipe is at least about 2 inches.

10. The emergence trap of claim 2 wherein the supporting rods comprise PVC pipe.

11. The emergence trap of claim 10 wherein the diameter of the PVC pipe is at least about one-half inch.

12. The emergence trap of claim 1 wherein the screen material comprises fiberglass window screen.

13. The emergence trap of claim 1 wherein the ventilated container comprises a translucent material.

14. The emergence trap of claim 1 further comprising at least one anchor line attached to said trap, wherein said anchor line is adapted to anchor into the ground under a body of water.

15. The emergence trap of claim 1 further comprising at least one eyelet attached to the base of the trap, said eyelet adapted to loosely surround a stake.
